(19) United States
(12) Patent Application Publication
(10) Pub. No.: US 2010/0208814 A1
(43) Pub. Date: Aug. 19, 2010

(54) Inter-frame prediction coding method and device

(75) Inventors: Lianhuan Xiong, Shenzhen (CN); Steffen Kamp, Aachen (DE); Michael Evertz, Aachen (DE); Mathias Wien, Aachen (DE)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/761,229

(22) Filed: Apr. 15, 2010

Related U.S. Application Data
(63) Continuation of application No. PCT/CN2008/072690, filed on Oct. 15, 2008.

(30) Foreign Application Priority Data
Oct. 15, 2007 (CN) 200710181831.3
Jan. 8, 2008 (CN) 200810002875.X

(51) Int. Cl. H04N 7/32

(52) U.S. Cl. 375/240.13; 375/E07.243

(57) ABSTRACT

An inter-frame prediction coding method is disclosed, which comprises: an encoder determines an encoding mode and performs encoding by comparing the obtained template matching motion vector and motion vector prediction value of the current block; a decoder receives the bitstream from the encoder, and determines a decoding mode and performs decoding by comparing the obtained template matching motion vector and motion vector prediction value of the current block. Inter-frame prediction encoding device and decoding device are also disclosed. With the method and device of the embodiments of the present invention, code rate can be saved during inter-frame prediction.

### CROSS-REFERENCE TO RELATED APPLICATIONS

This application is a continuation of International Application No. PCT/CN2008/072690, filed on Oct. 15, 2008, which claims priority to Chinese Patent Application No. 200710181831.3, filed on Oct. 15, 2007 and Chinese Patent Application No. 200810002875.X, filed on Jan. 8, 2008, all of which are hereby incorporated by reference in their entireties.

### FIELD OF THE INVENTION

The present invention relates to a video coding technology, and more particularly to inter-frame prediction coding method and device.

### RELATED ART

In video coding based on hybrid coding technology, inter-frame prediction technology is widely applied. The inter-frame prediction is a technology for image prediction based on adjacent frames by using time redundancy of data, namely the correlation of pixels among adjacent frames in a motion image sequence. Statistically, the luminance value of only less than 10% of the pixels changes more than 2% in two subsequent frames of a motion image, while the chromatic value changes even less.

Currently, variations in motion-compensation based inter-frame prediction technology are reflected by differences in the number of reference frames, reference direction, pixel precision and size division of block. The technical essentials include the following:

1. Use of matching blocks of different sizes, such as a 16×16 macroblock, or the 16×16 macroblock being further divided into smaller blocks sized as for instance 16×8, 8×16, 8×8 and 4×4 to perform motion matching search; 2. Motion vector precision and pixel interpolation; motion estimation includes integral pixel motion estimation and non-integral pixel motion estimation, and the non-integral pixel motion estimation further includes half-pixel motion estimation and quarter-pixel motion estimation; 3. Reference frame, including forward reference frame and backward reference frame, or single reference frame and multiple reference frames; 4. Motion vector (MV) prediction, wherein an encoded motion vector is used to predict the current motion vector, and the difference between the current vector and the predicted vector is subsequently transmitted.

Based on the inter-frame prediction technology, video coding standards currently available and coding standards under formulation, such as H.264, digital audio/video coding technology standard workgroup (AVS), H.264 scalable video coding (SVC) and H.264 multi-view video coding (MVC), all propose motion-compensation based inter-frame prediction technology, as the technology is capable of greatly improving coding efficiency.

In inter-frame prediction with motion compensation, the motion estimation technology is employed at the encoder to obtain motion vector information for motion estimation, and the motion vector information is written into the bitstream for transmission to the decoder. The bitstream transmitted from the encoder further includes macroblock type and residual information. The decoder uses the motion vector information decoded from the bitstream to perform motion compensation to thereby decode the image. The motion vector information takes a great part of the bitstream in the image bitstream encoded by using inter-frame prediction technology.

FIG. 1 is a schematic diagram illustrating implementation of a conventional motion-compensation based inter-frame prediction technology. As shown in FIG. 1, an input frame is stored in a frame memory after going through such processes as transform calculation, quantization, inverse quantization and inverse transform; subsequently, the system performs motion estimation for the currently input frame according to the previous frame stored in the frame memory to obtain motion vector, wherein the motion estimation process can be performed by using any motion estimation algorithm in the conventional art; motion compensation is performed according to the motion estimation result; the result after motion compensation is subjected to such processes as transform calculation, quantization and encoding, and output to the decoder.

Many motion-compensation based inter-frame prediction technologies have been defined in the conventional art. For instance, in the inter-frame prediction of a conventional H.264/advanced video coding (AVC), the decoder generates a prediction signal of a corresponding position in the reference frame according to the motion vector information decoded from the bitstream, and obtains luminance value of the pixel at the corresponding position after the decoding according to the obtained prediction signal and residual information carried in the bitstream, namely transform coefficient information; while motion vector information of the current block is encoded at the encoder, the motion vectors of the blocks adjacent to the current block are used to perform motion vector prediction of the current block to reduce bitstream necessary to transmit motion vector information of the current block.

FIG. 2 is a schematic diagram illustrating a conventional motion vector prediction mode. In FIG. 2, the motion vector prediction (MVP) value of the current block can be deduced from the motion vectors of blocks A, B, C and D adjacent to the current block. The current block in this context can be a macroblock, a block or division. According to the division of the current block, the prediction of MVP can be classified into middle value prediction and non-middle value prediction. When the current block is divided as shown in FIG. 3, non-middle value prediction can be employed. Specifically, if it is divided into 8×16 blocks, when the left block is the current block, its MVP equals to MVA (the motion vector of the adjacent block A), and when the right block is the current block, its MVP equals to MVC; if it is divided into 16×8 blocks, MVP of the upper block equals to MVB, and MVP of the lower block equals to MVA. Middle value prediction can be employed in the remaining circumstances, i.e. MVP of the current block equals to a middle value of MVA, MVB and MVC.

After MVP of the current block is obtained, motion vector difference (MVD) can be further calculated, namely MVD=MV−MVP, where MV is the motion vector of the current block estimated by using any conventional motion estimation algorithm. Then, MVD is entropy encoded, written into the bitstream, and transmitted to the decoder.

Although the foregoing process can achieve motion-compensation based inter-frame prediction, this process requires that the motion vector information is explicitly written into the bitstream for subsequent transmission to the decoder, which additionally increases code rates.

In conventional motion-compensation based inter-frame prediction technologies, a Skip mode is provided in addition to using the motion vector prediction technology to improve coding efficiency. The bitstream to which the mode corresponds merely carries therewith macroblock mode information in the macroblock type, and does not carry motion vector information and residual information. in this case, the decoder can obtain the motion vectors of the blocks adjacent to the macroblock in the current frame according to the macroblock mode information decoded from the received bitstream, and deduce the motion vector of the current block according to the motion vector information of the adjacent block. The reconstruction value of the current block can be replaced with a prediction value at a corresponding position of the reference frame after determining the corresponding position of the current block in the reference frame according to the motion vector information of the current block.

A conventional inter-frame prediction mode is also based on the template matching technology. The template matching technology is for deducing a prediction signal for a target region of N×N pixels, namely the current block. Because the target region is not yet reconstructed, it is possible to define a template in reconstructed regions adjacent to the target region. FIG. 4 is a schematic diagram illustrating a conventional way of defining a template. In general, an L-shaped region is selected from the upper and left regions of the target region as a template. The template size M is defined as the number of pixels in a horizontal direction starting from the left side of the left boundary of the target region covered by the template, and it can of course also be defined as the number of pixels in a vertical direction starting from the upper side of the upper boundary of the target region covered by the template. As can be known from FIG. 4, the number of pixels of the region covered by the template is 2×N×M+M×M.

In practical application, templates of other shapes can be used in addition to the L-shaped. It is also possible to set different weights for different regions in the template to increase precision during subsequent calculation of cost function.

The process of executing template matching is similar to the matching mode in conventional motion estimation, namely to calculate the cost function of the template corresponding to different positions during search in different regions of the reference frame. The cost function in this context can be an absolute sum of the pixels in the template region and the corresponding pixels in regions during matching search in the reference frame. Of course, the cost function can also be a variance or other cost functions including flat restriction to the motion vector field. The searching process of template matching can be performed in different searching ranges or with different searching modes upon practical demand; for instance, the searching mode that combines integral-pixel with half-pixel can be employed to reduce complexity of the template matching process.

In the template matching inter-frame prediction mode, the bitstream transmitted from the encoder to the decoder includes the macroblock type information of the current block, and can further include the residual information. On receipt of the bitstream, the decoder finds out the motion vector corresponding to the current block in the template matching mode, then finds out the corresponding position of the current block in the reference frame, and takes the pixel value at the corresponding position or the pixel value at the corresponding position plus the residual information as the pixel value of the current block after decoding.

When the template matching mode is employed to perform encoding, it is required to add a macroblock type to identify whether the current block is encoded in the currently available motion compensation mode or the template matching mode. However, in this case, because it is required to introduce a particular macroblock type to transmit identifier information of the template matching mode, additional code rate is increased.

During implementation of this invention, the inventors found that it is necessary to add additional bitstream information in a conventional encoding process, and the code rate is increased in various degrees.

### SUMMARY OF THE INVENTION

An embodiment of the present invention provides an inter-frame prediction encoding method capable of saving code rates during the process of inter-frame prediction.

An embodiment of the present invention provides an inter-frame prediction decoding method capable of saving code rates during the process of inter-frame prediction.

An embodiment of the present invention provides an inter-frame prediction encoding device capable of saving code rates during the process of inter-frame prediction.

An embodiment of the present invention provides an inter-frame prediction decoding device capable of saving code rates during the process of inter-frame prediction.

The technical solutions of embodiments of the present invention are realized as follows.

An embodiment of the present invention provides an inter-frame prediction encoding method. The method includes: obtaining a template matching motion vector and a motion vector prediction value of a current block; comparing the template matching motion vector and the motion vector prediction value, determining an encoding mode according to the comparing result, and performing encoding.

An embodiment of the present invention provides an inter-frame prediction decoding method. The method includes: receiving a bitstream from an encoder; obtaining a template matching motion vector and a motion vector prediction value of a current block; comparing the template matching motion vector and the motion vector prediction value, determining a decoding mode according to the comparing result, and performing decoding.

An embodiment of the present invention provides an inter-frame prediction encoding device. The device includes: an obtaining unit configured to obtain a template matching motion vector and a motion vector prediction value of a current block; and a determining unit configured to compare the template matching motion vector and the motion vector prediction value, determine an encoding mode according to the comparing result, and perform encoding.

An embodiment of the present invention provides an inter-frame prediction decoding device. The device includes: a determining unit configured to receive a bitstream from an encoder, compare obtained template matching motion vector and motion vector prediction value of a current block, and determine a decoding mode according to the comparing result; and a decoding unit configured to perform decoding according to the determined decoding mode.

An embodiment of the present invention provides an inter-frame prediction decoding method. The method includes: receiving a bitstream from an encoder; presetting a template matching motion vector of a current block or determining template matching block information to obtain the template matching motion vector of the current block; obtaining the template matching motion vector of the current block, and performing decoding in a template matching mode according to a flag which indicates whether to use the template matching technology and is carried in the bitstream.

The embodiments of the present invention possess the following advantages:

The technical solutions recited in the embodiments of the present invention flexibly select an optimized encoding and decoding mode that is most suited to the actual situation according to the obtained template matching motion vector and motion vector prediction value of the current block, so as to achieve the object of saving code rates in the maximum degree.

### BRIEF DESCRIPTION OF THE DRAWINGS

FIG. 1 is a schematic diagram illustrating a conventional implementation of the motion-compensation based inter-frame prediction technology;

FIG. 2 is a schematic diagram illustrating a conventional motion vector prediction mode;

FIG. 3 is a schematic diagram illustrating the conventional division of the current block;

FIG. 4 is a schematic diagram illustrating a conventional way of defining a template;

FIG. 5 is a flowchart illustrating a method embodiment of the present invention;

FIG. 6 is a flowchart illustrating encoding at the encoder in a method embodiment of the present invention;

FIG. 7 is a flowchart illustrating decoding at the decoder in a method embodiment of the present invention;

FIG. 8 is a schematic diagram illustrating the structure of an encoding device embodiment according to the present invention;

FIG. 9 is a schematic diagram illustrating the structure of a decoding device embodiment according to the present invention; and

FIG. 10 is a schematic diagram illustrating comparison encoding performance between technical solutions of embodiments of the present invention and the conventional approach.

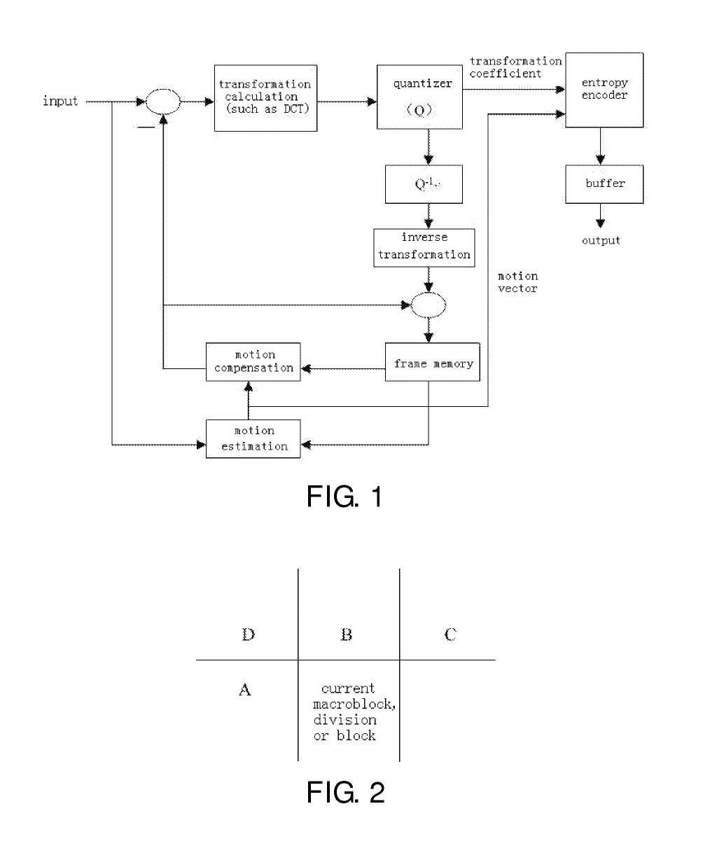

### DETAILED DESCRIPTION

To make more apparent the objects, technical solutions and advantages of the present invention, the present invention is described in further detail below with reference to the accompanying drawings and embodiments.

In the embodiments of the present invention, the grammar element information contained in the bitstream is determined as follows: With the characteristic of generating motion vector information in template matching mode, the motion vector generated in template matching and the conventional motion vector prediction value are taken as contextual information. The motion vector and the motion vector prediction value are compared when the current block is encoded. In this way, the grammar element information is determined. The embodiments of the present invention can be implemented based on the P-Skip technology in the Skip technology of the conventional art.

The technical solutions recited in the embodiments of the present invention extend the existing P-Skip technology to provide a template matching prediction method that is based on a condition encoding flag. In the embodiments of the present invention, a macroblock adaptively changes the motion characteristic without special information about encoding motion vectors, and only few additional encoding is required.

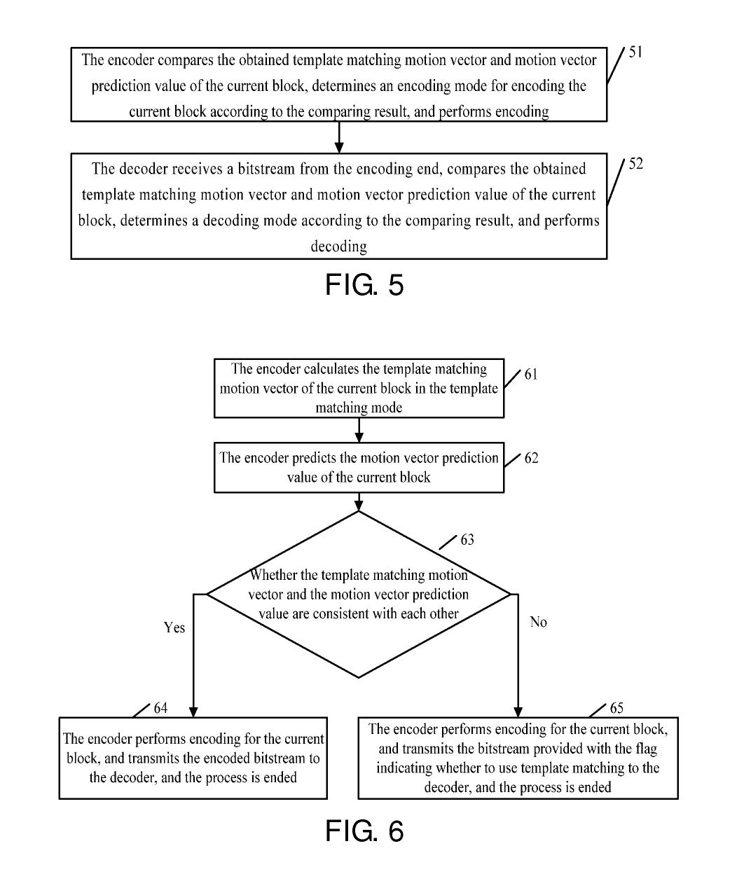

FIG. 5 is a flowchart illustrating a method embodiment of the present invention. As shown in FIG. 5, the method includes the following steps.

Step 51: The encoder compares the obtained template matching motion vector (TM_MV) and motion vector prediction value of the current block, determines an encoding mode for encoding the current block according to the comparing result, and uses the determined encoding mode to perform encoding.

In this step, the way in which the encoder determines the encoding mode and performs encoding may be as follows: The encoder determines a bitstream element for encoding the current block, performs encoding according to the determined bitstream element, and transmits the bitstream to the decoder. The bitstream element in this embodiment is a macroblock type and/or a flag which indicates whether to use template matching. The way in which the encoder determines the bitstream element for encoding the current block may be as follows: The encoder determines whether the template matching motion vector and the motion vector prediction value of the current block are consistent with each other. If the two are consistent with each other, only the macroblock type information is encoded into the bitstream; if the two are inconsistent with each other, the macroblock type and flag indicating whether to use template matching are encoded into the bitstream, to instruct the decoder to decode the received bitstream in the template matching mode or the motion compensation mode.

The method further includes, before encoding the macroblock type and the flag indicating whether to use template matching in the bitstream: the encoder determines whether the decoder is instructed to decode the bitstream in the template matching mode or the motion compensation mode. For instance, the encoder employs a rate-distortion optimization (RDO) algorithm to compare the rate-distortion performances of coding by using the template matching motion vector and the motion vector prediction value, and instructs the decoder to perform decoding in the mode with better rate-distortion performance.

Step 52: The decoder receives a bitstream from the encoder, compares the obtained template matching motion vector and motion vector prediction value of the current block, determines a decoding mode according to the comparing result, and performs decoding.

In this step, the decoder determines whether the inter-frame prediction mode for the current block is a P_Skip mode according to the macroblock type information carried in the received bitstream. If the inter-frame prediction mode is a P_Skip mode, the decoder compares whether the obtained template matching motion vector and motion vector prediction value of the current block are consistent with each other. If the two are consistent with each other, the bitstream is decoded in the motion compensation mode; if the two are inconsistent with each other, decoding is performed in the template matching mode or the motion compensation mode according to the flag which indicates whether to use template matching and is carried in the bitstream. When parsing the boundary information of the current macroblock, the decoder obtains the template matching motion vector of the current macroblock by finding out matching block information in the reference frame of the current piece, where the matching block information is found out by decoding and reconstructing the pixels of the template. The parsing process and the decoding process are implemented in a mixed manner.

In another embodiment, step 52: The decoder receives a bitstream from the encoder, presets the template matching motion vector of the current block or determines the template matching block information to obtain the template matching motion vector of the current block, obtains the template matching motion vector of the current block, and performs decoding in the template matching mode according to the flag which indicates whether to use template matching and is carried in the bitstream.

In this step, the decoder determines whether the inter-frame prediction mode for the current block is a P_Skip mode according to macroblock type information carried in the received bitstream. If the inter-frame prediction mode for the current block is a P_Skip mode and the template matching motion vector of the current block in the macroblock can be obtained, the decoder determines whether the obtained template matching motion vector and motion vector prediction value of the current block are consistent with each other. If the two are consistent with each other, the bitstream is decoded in the motion compensation mode; if the two are inconsistent with each other, decoding is performed in the template matching mode or the motion compensation mode according to the flag which indicates whether to use template matching and is carried in the bitstream. If the template matching motion vector of the current block in the macroblock cannot be obtained, decoding is performed in the template matching mode or the motion compensation mode according to the flag which indicates whether to use template matching and is carried in the bitstream. The parsing process and the decoding process are separately implemented.

The technical solutions of the present invention are described in further detail below for the encoder and the decoder, each, by specific embodiments.

FIG. 6 is a flowchart illustrating encoding at the encoder in a method embodiment of the present invention. As shown in FIG. 6, the method includes the following steps.

Step 61: The encoder calculates the template matching motion vector of the current block in the template matching mode.

In this step, when the encoder needs to encode the current block, the encoder first calculates the template matching motion vector of the current block in the template matching mode. The specific way of calculation is the same as that in the conventional art. That is, matching search is performed in the reference frame for a pre-selected template region, such as an L-shaped template region, to find the optimum matching position, and the motion vector of the current block is calculated according to this position, namely a position offset of the current block in the current frame and in the reference frame.

Step 62: The encoder predicts the motion vector prediction value of the current block.

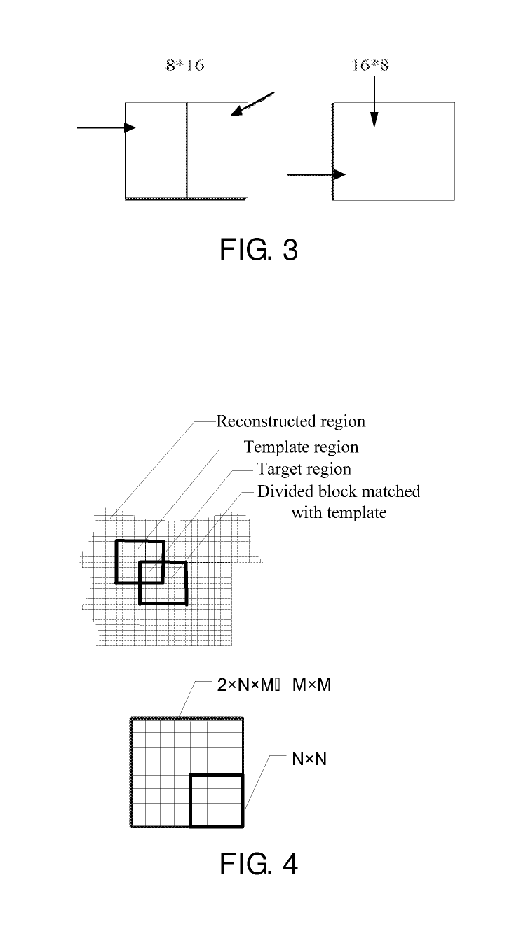

Referring to FIG. 2 and FIG. 3 for the specific way of prediction, the encoder predicts the motion vector prediction value of the current block according to the motion vectors of blocks A, B, C and D adjacent to the current block. According to the division of the current block, the prediction of MVP can be classified into middle value prediction and non-middle value prediction. When the current block is divided as shown in FIG. 3, non-middle value prediction can be employed. Middle value prediction can be employed in other circumstances, that is, MVP of the current block equals to a middle value of MVA, MVB and MVC.

Step 63: The encoder determines whether the template matching motion vector and the motion vector prediction value are consistent with each other. If the two are consistent with each other, step 64 is performed; if the two are inconsistent with each other, the process goes to step 65.

Step 64: The encoder performs encoding for the current block, and transmits the encoded bitstream to the decoder, and the process ends.

In this step, because the template matching technology motion vector and the motion vector prediction value are consistent with each other, the encoder does not encode the flag indicating whether to use template matching during the encoding process. Thus, the bitstream transmitted from the encoder to the decoder contains only macroblock type information.

Step 65: The encoder performs encoding for the current block, and transmits the bitstream provided with the flag indicating whether to use template matching to the decoder, and the process ends.

Because the template matching technology motion vector and the motion vector prediction value are inconsistent with each other, it is necessary for the encoder to add a flag indicating whether to use template matching to the encoded bitstream. Prior to this, the encoder should first determine whether the decoder is instructed to perform decoding in the template matching mode or the motion compensation mode according to the flag indicating whether to use template matching. The process of determining the decoding mode includes: The encoder encodes and decodes the template matching motion vector and the motion vector prediction value separately, determines which of the two rounds of encoding and decoding has better performance by a rate-distortion optimization algorithm, for instance by comparing which round of encoding has the minimum deviation between the reconstructed image and the original image, and determines the specific setup of the flag indicating whether to use template matching according to the comparing result.

In specific implementation, it is possible to set a bit in the bitstream as the flag bit indicating whether to use template matching. If the way of coding according to the template matching motion vector has better performance, the flag bit indicating whether to use template matching is set as 1; if the way of coding according to the motion vector prediction value has better performance, the flag indicating whether to use template matching is set as 0.

In this step, the bitstream transmitted from the encoder to the decoder contains the macroblock type and the flag indicating whether to use template matching.

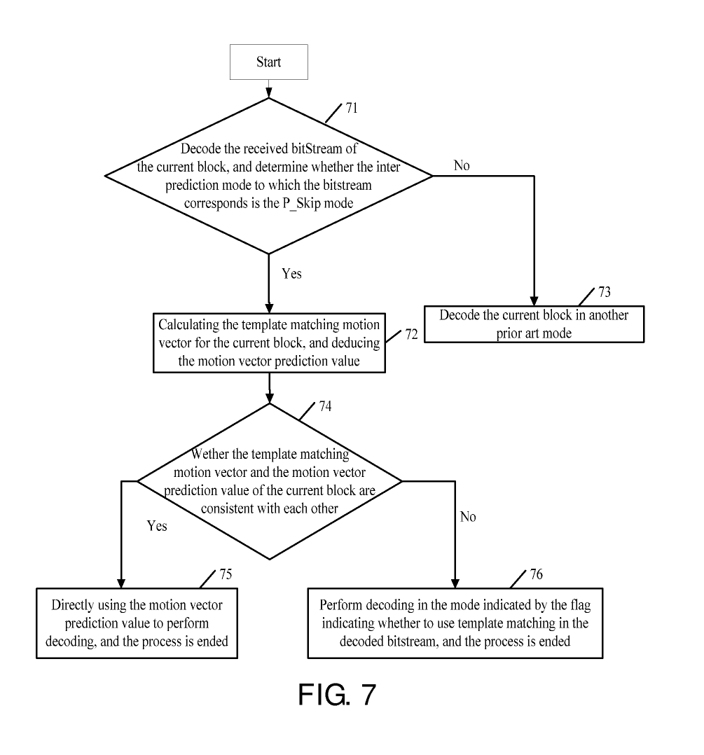

In the subsequent process, the decoder performs decoding according to the received bitstream. FIG. 7 is a flowchart illustrating decoding at the decoder in a method embodiment of the present invention. As shown in FIG. 7, the method includes the following steps.

Step 71: The decoder decodes the received bitstream of the current block, and determines whether the inter prediction mode to which the bitstream corresponds is the P_Skip mode. If yes, step 72 is performed; otherwise the process goes to step 73.

In this step, the decoder determines whether the inter-frame prediction mode to which the bitstream corresponds is the P_Skip mode according to the macroblock type information carried in the bitstream. The macroblock type information can be provided with a particular flag in an artificially prescribed way to indicate that the inter-frame prediction mode to which the bitstream corresponds is the P_Skip mode.

Step 72: The decoder calculates the template matching motion vector for the current block, and deduces the motion vector prediction value, and the process goes to step 74.

The way of obtaining the template matching motion vector and the motion vector prediction value is the same as that in the conventional art, and is hence not described here.

During the process of calculating the template matching motion vector, the obtained motion vector prediction value can be taken as a center to search within a predetermined region around the center, so as to quicken the searching process.

Step 73: The decoder decodes the current block in another conventional mode. Because this is irrelevant to the present invention, the specific decoding process is not described here.

Step 74: The decoder determines whether the template matching motion vector and the motion vector prediction value of the current block are consistent with each other. If the two are consistent with each other, the process goes to step 75; if the two are inconsistent with each other, the process goes to step 76.

Step 75: The decoder directly uses the motion vector prediction value to perform decoding, and the process ends.

If the template matching motion vector and the motion vector prediction value are consistent with each other, there is no flag indicating whether to use template matching in the bitstream, so that it is possible for the decoder to directly use the motion vector prediction value of the current block to perform decoding. The specific way of decoding is the same as that in the conventional art, and is hence not described here.

Step 76: The decoder performs decoding in the mode indicated by the flag indicating whether to use template matching carried in the decoded bitstream, and the process ends.

In this step, the decoder selects a motion vector according to the flag bit indicating whether to use template matching carried in the decoded bitstream, and performs subsequent decoding, and the process ends.

For instance, if the flag bit indicating whether to use template matching is set as 1, the decoder performs decoding in the template matching mode; if the flag indicating whether to use template matching is set as 0, the decoder performs decoding by using the motion vector precision value in the motion compensation mode. The process of decoding pertains to conventional art, and is hence not described here.

As should be noted, in this embodiment, because the bitstream transmitted from the encoder does not contain residual information, it is merely necessary in the subsequent decoding process by the decoder to take the pixel value at the position in the reference frame corresponding to the current block as the pixel value of the current block after decoding.

In another embodiment, for the decoder, step 1 of the embodiment is the same as the foregoing step 71.

In this step, the decoder determines whether the inter-frame prediction mode to which the bitstream corresponds is the P_Skip mode according to the macroblock type information carried in the bitstream. The macroblock type information can be provided with a particular flag in an artificially prescribed mode to indicate that the inter-frame prediction mode to which the bitstream corresponds is the P_Skip mode.

Step 2: The decoder calculates the template matching motion vector for the current block, and deduces the motion vector prediction value. If the template matching motion vector of the current block of the macroblock is unavailable, the process goes to step 3; if the template matching motion vector is available, the process goes to step 4.

Steps 4-6 are the same as the foregoing steps 74-76.

In step 6, the decoder selects a corresponding motion vector according to the indication of the flag bit indicating whether to use template matching in the decoded bitstream, performs subsequent decoding, and the process ends.

For instance, if the flag bit indicating whether to use template matching is set as 1, the decoder performs decoding in the template matching mode. In this case, the template matching motion vector is preset as 0 or the template information originally required for encoding is made to equal to the previous encoding template information, to be used for finding out the matching block information to obtain the template matching motion vector of the current block; if the flag bit indicating whether to use template matching is set as 0, the decoder uses the motion vector precision value to perform decoding in the motion compensation mode. The specific way of decoding pertains to conventional art, and is hence not described here.

To achieve the processes shown in FIG. 6 and FIG. 7, the grammar of the current P_Skip mode should be modified, the modified grammar of the P_Skip mode is as follows:

| | | |
|---|---|---|
| | | De- |
| slice_data( ) { | C | scriptor |

if( entropy_coding_mode_flag )

while( !byte_aligned( ) )

| | | |
|---|---|---|
| cabac_alignment_one_bit | 2 | f(1) |

CurrMbAddr = first_mb_in_slice * ( 1 +
MbaffFrameFlag )
moreDataFlag = 1
prevMbSkipped = 0
do {

if( slice_type != I && slice_type != SI )

if( !entropy_coding_mode_flag ) {

| | | |
|---|---|---|
| mb_skip_run | 2 | ue(v) |
| prevMbSkipped = ( mb_skip_run > 0 ) | | |
| for( i=0; i<mb_skip_run; i++ ) | | |

CurrMbAddr = NextMbAddress( CurrMbAddr )

moreDataFlag = more_rbsp_data( )

} else {

| | | |
|---|---|---|
| mb_skip_flag | 2 | ae(v) |
| if( mb_skip_flag && UseTMVector( ) ) | | |

| | | | |
|---|---|---|---|
| tm_active_flag | //flag indicating | 2 | ae(v) |

whether to use template

moreDataFlag = !mb_skip_flag

}

...

} while( moreDataFlag )

}

The function UserTMVector( ) is used to perform the template matching operation. If the template matching motion vector and the motion vector prediction value of the current block are inconsistent, the function returns true, and otherwise returns false.

As should be noted, the description of the embodiments shown in FIG. 6 and FIG. 7 involves merely the single color component signal, namely luminance value. In practical application, by extending the target and template regions to pixels of identical positions of all components, the technical solutions of the embodiments of the present invention can also be applied to multi-component signals. But, if different components use different sampling rates, certain restrictive conditions should be satisfied. For instance, with regard to color sub-samples having the ratio of Y:Cb:Cr as 4:2:0, where Y indicates a luminance component, Cb indicates a blue chromatic component, and Cr indicates a red chromatic component, the size of the template region should be double size of the target region. Moreover, the technical solutions of the embodiments of the present invention are not only applicable to the single-view video coding environment as shown in FIG. 6 and FIG. 7, but are also applicable to the multi-view video coding environment.

Moreover, in the embodiments as shown in FIG. 6 and FIG. 7, the motion vector generated by template matching can be taken as the motion vector prediction value of the current block; that is, the motion vector currently generated by the template matching technology can be used for motion vector prediction of the subsequent current block, to function in the processes of rate-distortion optimization and MVD calculation and coding, thereby providing the current block with more applicability of motion vector prediction, and improving the precision in motion vector prediction.

The template matching motion vector and the motion vector prediction value in the embodiments shown in FIG. 6 and FIG. 7 can be further used as contextual information to select a contextual model when the current block is coded. For instance, with regard to the Context-based Arithmetic Coding CABAC, it is possible to use the comparing relationship between the template matching motion vector and the motion vector prediction value to decide the probability model for performing CABAC coding for the current block information. The specific process of encoding is as follows: calculating the template matching motion vector of the current block and obtaining the motion vector prediction value; comparing the template matching motion vector and the motion vector prediction value, if the two are consistent with each other, a probability model P1 is selected to encode the current block; if the two are inconsistent with each other, a probability model P2 is selected to perform encoding.

The specific process of decoding is as follows: calculating the template matching motion vector of the current block and obtaining the motion vector prediction value; comparing the template matching motion vector and the motion vector prediction value, if the two are consistent with each other, the probability model P1 is selected to decode the current block; if the two are inconsistent with each other, the probability model P2 is selected to perform decoding.

Because CABAC coding belongs to the conventional art, and it should be clear for a person skilled in the art to understand its realization process; therefore, it is not described here.

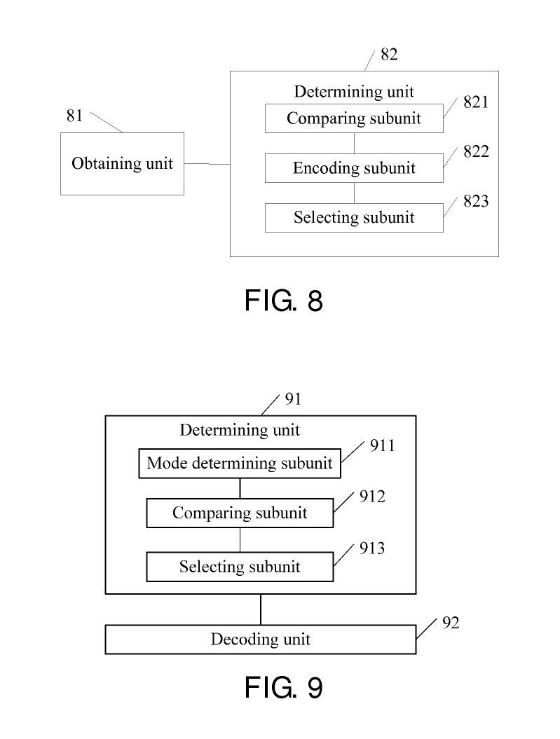

Based on the foregoing methods, FIG. 8 is a schematic diagram illustrating the structure of an encoding device embodiment according to the present invention. As shown in FIG. 8, the device includes: an obtaining unit 81 configured to obtain a template matching motion vector and a motion vector prediction value of a current block; and the determining unit 82 configured to compare whether the template matching motion vector information and the motion vector prediction value are consistent with each other, determine an encoding mode according to the comparing result and perform encoding.

The determining unit 82 includes: a comparing subunit 821 configured to determine whether the template matching motion vector and the motion vector prediction value of the current block are consistent with each other, and transmit the comparing result to an encoding subunit 822; and the encoding subunit 822 configured to perform encoding according to the comparing result, encode only macroblock type information into the bitstream if the comparing result is that the two are consistent with each other, and encode the macroblock type and a flag indicating whether to use template matching into the bitstream if the comparing result is that the two are inconsistent with each other, to instruct the decoder to decode the bitstream in a template matching mode or a motion compensation mode. The encoding subunit 822 is further configured to compare different performances of coding by using the template matching motion vector and the motion vector prediction value and instruct the decoder to perform decoding in the mode with better performance, if the comparing result is that the two are inconsistent with each other.

The determining unit 82 may further include: a selecting subunit 823 configured to select a model to encode the current block according to the comparing result of the template matching motion vector and the motion vector prediction value of the current block, and notify the encoding subunit 822.

FIG. 9 is a schematic diagram illustrating the structure of a decoding device embodiment according to the present invention. As shown in FIG. 9, the device includes: a determining unit 91 configured to receive a bitstream from the encoder, compare whether an obtained template matching motion vector and motion vector prediction value of a current block are consistent with each other, and determine a decoding mode according to the comparing result; and a decoding unit 92 configured to perform decoding according to the determined decoding mode.

The determining unit 91 may include: a comparing subunit 912 configured to receive a bitstream from the encoder, compare whether the template matching motion vector and the motion vector prediction value of the current block are consistent with each other, notify the decoding unit 92 to decode the bitstream in a motion compensation mode if the two are consistent with each other, and notify the decoding unit 92 to perform decoding in a template matching mode or the motion compensation mode if the two are inconsistent with each other, according to a flag which indicates whether to use template matching and is carried in the bitstream.

Moreover, the determining unit 91 may further include: a mode determining subunit 911 configured to notify the comparing subunit 912 to perform its own function after determining that the inter-frame prediction mode for the current block is a P_Skip mode according to the macroblock type information carried in the received bitstream; and a selecting subunit 913 configured to select a model to decode the bitstream according to the comparing result of the template matching motion vector and the motion vector prediction value of the current block, and notify the decoding unit 92.

Refer to the description of the corresponding methods for the specific operational processes of the embodiments of FIG. 8 and FIG. 9, and therefore are not described here.

Seen as such, with the technical solutions of the embodiments according to the present invention, the template matching motion vector and the motion vector prediction value are taken as contextual information, and the information contained in the current bitstream is determined and coded by comparison. Because the technical solutions of the embodiments according to the present invention are based on the P_Skip mode, no additional bitstream is increased, whereby it is possible to save the transfer cost used for transferring the motion vector, and more options are provided for the motion vector prediction. At the same time, the contextual decision information such as entropy coding can be provided as information available by both of the encoder and the decoder for the current coding, thereby improving adaptability of the technology, and improving coding efficiency.

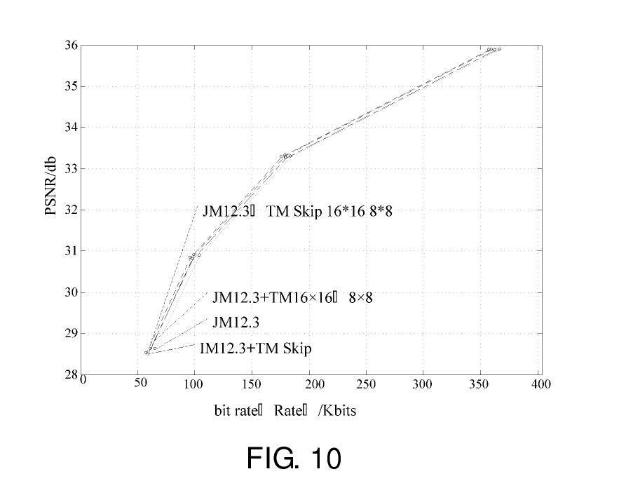

FIG. 10 is a schematic diagram illustrating comparison between the technical solutions of embodiments of the present invention and the conventional approached in terms of encoding performance. As shown in FIG. 10, supposing that the sequence coding type is IPPP, that is to say, the first frame is encoded in the intraframe prediction mode, while the remaining frames are encoded in the inter-frame prediction mode, wherein JM12.3 is the technical effect of using the conventional motion compensation mode on the H.264/AVC platform; TM Skip is the technical effect of using the technical solutions of the present invention on the H.264/AVC platform; TM 16×16 8×8 is the technical effect of using the conventional template matching mode; and TM Skip 16×16 8×8 is the technical effect of using the conventional template matching mode in combination with the technical solutions of the present invention. The horizontal coordinate in FIG. 10 represents the code rate, and the vertical coordinate represents the signal-to-noise ratio (PSNR), namely the difference between the reconstructed image and the original image. As can be seen from FIG. 10, an excellent effect of saving code rate can be achieved by the technical solutions of the embodiments according to the present invention.

As should be clear to a person skilled in the art through the above descriptions of the embodiments, the present invention can be implemented via hardware, or via software and necessary hardware general platform. Based on such understanding, the technical solutions of the present invention can be embodied in the form of a software product, which can be stored in a nonvolatile storage medium (such as a CD-ROM, a U disk, or a movable hard disk) and contains a plurality of instructions enabling a computer device (such as a personal computer, a server, or a network device) to execute the methods recited in the embodiments of the present invention.

In summary, the above descriptions are merely preferred embodiments of the present invention, which not restrict the protection scope of the present invention. All modifications, equivalent substitutions and improvements made without departing from the spirits and principles of the present invention shall fall within the protection scope of the present invention.

1. An inter-frame prediction encoding method, comprising:
obtaining a template matching motion vector and a motion vector prediction value of a current block;
comparing the template matching motion vector and the motion vector prediction value, and determining an encoding mode according to the comparing result; and
performing encoding by using the determined encoding mode.

2. The method according to claim 1, wherein the steps of determining an encoding mode according to the comparing result and performing encoding comprise:
determining a bitstream element required for encoding the current block according to the comparing result, and performing encoding in different encoding modes according to the determined bitstream element.

3. The method according to claim 2, wherein the bitstream element is one of a macroblock type and a flag indicating whether to use template matching; and wherein the step of determining a bitstream element required for encoding the current block according to the comparing result comprises:
encoding only macroblock type into a bitstream if the template matching motion vector and the motion vector prediction value of the current block are consistent with each other; if the two are inconsistent with each other, encoding the macroblock type and the flag indicating whether to use template matching into the bitstream, to instruct a decoder to decode the bitstream in a template matching mode or a motion compensation mode.

4. The method according to claim 3, further comprising, before encoding the macroblock type and the flag indicating whether to use template matching into the bitstream: determining whether the decoder is instructed to decode the bitstream in the template matching mode or the motion compensation mode, comprising:
comparing different performances of coding by using the template matching motion vector and the motion vector prediction value, and instructing the decoder to perform decoding in the mode with better performance.

5. The method according to claim 1, wherein during the process of obtaining the template matching motion vector of the current block, the motion vector prediction value of the current block is taken as a center to perform matching search within a predetermined range around the center.

6. The method according to claim 1, wherein the step of determining an encoding mode according to the comparing result comprises:
selecting a model to encode the current block according to the comparing result, and performing encoding according to the selected encoding model.

7. The method according to claim 1, further comprising, after determining an encoding mode according to the comparing result and performing encoding:
using the obtained template matching motion vector for motion vector prediction of a subsequent current block.

8. An inter-frame prediction decoding method, comprising:
receiving a bitstream from an encoder;
obtaining a template matching motion vector and a motion vector prediction value of a current block;
comparing the template matching motion vector and the motion vector prediction value, and determining a decoding mode according to the comparing result; and
performing decoding by using the determined decoding mode.

9. The method according to claim 8, wherein the steps of determining a decoding mode according to the comparing result and performing decoding comprise:
decoding the bitstream in a motion compensation mode if the template matching motion vector and the motion vector prediction value of the current block are consistent with each other; if inconsistent, performing decoding in a template matching mode or the motion compensation mode according to a flag which indicates whether to use template matching and is carried in the bitstream.

10. The method according to claim 8, further comprising, before comparing the template matching motion vector and the motion vector prediction value:
determining that an inter-frame prediction mode for the current block is a P_Skip mode according to macroblock type carried in the bitstream.

11. The method according to claim 8, wherein during the process of obtaining the template matching motion vector of the current block, the motion vector prediction value of the current block is taken as a center to perform matching search within a predetermined range around the center.

12. An inter-frame prediction encoding device, comprising:
an obtaining unit configured to obtain a template matching motion vector and a motion vector prediction value of a current block; and
a determining unit configured to compare the template matching motion vector and the motion vector prediction value, determine an encoding mode according to the comparing result, and perform encoding.

13. The device according to claim 12, wherein the determining unit comprises:
a comparing subunit configured to compare the template matching motion vector and the motion vector prediction value of the current block, and transmit the comparing result to an encoding subunit; and
the encoding subunit configured to perform encoding according to the comparing result, encode only macroblock type into a bitstream if the comparing result is that the two are consistent with each other, and encode the macroblock type and a flag indicating whether to use template matching into the bitstream if the comparing result is that the two are inconsistent with each other, to instruct a decoder to decode the bitstream in a template matching mode or a motion compensation mode.

14. The device according to claim 13, wherein the encoding subunit is further configured to compare different performances of coding by using the template matching motion vector and the motion vector prediction value and instruct the decoder to perform decoding in the mode with better performance, if the comparing result is inconsistent.

15. The device according to claim 13, wherein the determining unit further comprises: a selecting subunit configured to select a model to encode the current block according to the result of comparing the template matching motion vector and the motion vector prediction value of the current block, performed by the comparing subunit, and notify the encoding subunit.

16. An inter-frame prediction decoding device, comprising:
a determining unit configured to receive a bitstream from an encoder, compare an obtained template matching motion vector and motion vector prediction value of a current block, and determine a decoding mode according to the comparing result; and
a decoding unit configured to perform decoding according to the determined decoding mode.

17. The device according to claim 16, wherein the determining unit comprises: a comparing subunit configured to receive the bitstream from the encoder, compare the template matching motion vector and the motion vector prediction value of the current block, notify the decoding unit to decode the bitstream in a motion compensation mode if the two are consistent with each other, and notify the decoding unit to perform decoding in a template matching mode or motion compensation mode according to a flag which indicates whether to use template matching and is carried in the bitstream if inconsistent.

18. The device according to claim 17, wherein the determining unit further comprises: a mode determining subunit configured to notify the comparing subunit to perform its own function after determining that an inter-frame prediction mode for the current block is a P_Skip mode according to macroblock type carried in the bitstream.

19. The device according to claim 17, wherein the determining unit further comprises: a selecting subunit configured to select a model to decode the current block according to the comparing result of the template matching motion vector and the motion vector prediction value of the current block by the comparing subunit, and notify the decoding unit.

20. An inter-frame prediction decoding method, comprising:
receiving a bitstream from an encoder;
presetting a template matching motion vector of a current block or determining a template matching block information to obtain the template matching motion vector of the current block; and
obtaining the template matching motion vector of the current block, and performing decoding in a template matching mode according to a flag which indicates whether to use template matching and is carried in the bitstream.

21. The method according to claim 20, further comprising, before obtaining the template matching motion vector of the current block:
determining that an inter-frame prediction mode for the current block is a P_Skip mode according to macroblock type carried in the bitstream.

22. The method according to claim 20, wherein presetting the template matching motion vector of the current block as 0 or making a template information required for decoding to be equal to previous decoding template information, so as to find out matching block information to obtain the template matching motion vector of the current block.
